(19) United States
(12) Patent Application Publication
(10) Pub. No.: US 2007/0199157 A1
(43) Pub. Date: Aug. 30, 2007

(54) Fabric conditioner enhancing agent and emulsion and dispersant stabilizer

(76) Inventors: Eduardo Torres, Boiling Springs, SC (US); Dominick J. Valenti, Greenville, SC (US); Emily W. Michaels, Greenville, SC (US); Scott M. Violette, Simpsonville, SC (US)

Correspondence Address: Cheryl J. Brickey;Milliken & Company, Legal Department, M-495, P.O. Box 1926, Spartanburg, SC, 29304, US

(21) Appl. No.: 11/645,277

(22) Filed: Dec. 22, 2006

Related U.S. Application Data
(60) Provisional application No. 60/777,320, filed on Feb. 28, 2006.
(60) Provisional application No. 60/783,961, filed on Mar. 20, 2006.

(51) Int. Cl. C11D 3/00

(52) U.S. Cl. 8/115.51

(57) ABSTRACT

The invention relates to a stable aqueous dispersion comprising a multi-branched soil release/wetting agent having an oxygen-containing polyfunctional base compound and at least two surfactant branches attached thereto, wherein each surfactant branch includes at least one hydrophilic and at least one hydrophobic constituent, wherein the multi-branched soil release/wetting agent is in an amount of between 0.05 and 3% by weight of the aqueous dispersion and particles selected from the group consisting of inorganic, organic, and polymeric particles having a size range between 50 nm and 45 μm, wherein the particle dispersion is stable for at least 10 days at 40° C. Enhanced fabric conditioners and the method of applying the enhanced fabric conditioners are also discussed.

### CROSS-REFERENCE TO RELATED PATENT APPLICATIONS

This application claims priority to U.S. Provisional Application 60/777,320 and 60/783,961 and are hereby incorporated by reference.

### FIELD OF THE INVENTION

The present invention generally relates to multi-branched soil release/wetting agents and gelling agents for use in emulsion systems such as fabric conditioner formulations by acting as: emulsion stabilizers, dispersant stabilizers, and/or thickening and gelling agents. More specifically, the invention relates to an enhanced fabric conditioner comprising a fabric conditioner and ethoxylated propoxylated triglycerides, ethoxylated propoxylated sorbitol.

### BACKGROUND OF THE INVENTION

In commercial liquid fabric softener formulations the rheological properties and stability of the product are critical for consumer acceptance. Conventionally, most liquid fabric conditioning or fabric softener compositions make use of the thickening properties of surfactant ingredients or added salts to provide a desired rheology which remains stable over extended periods of time.

Thickening of liquid laundry care agents (detergents, fabric softeners, etc.) is a major issue in this industry due to the complex nature of the formulations used in these liquid systems. The cationic surfactants are disrupted and rendered ineffective by a wide range of materials. Anionic species, either dissolved or suspended may adsorb or precipitate the surfactant, causing both rheological and physical instability i.e. the product may become too thick or too thin, or phase separation of the aqueous phase may occur. Thus, unless used to form neutral fatty softening species or to deliberately thin the formulation e.g. liquid concentrates, anionic surfactants and additives are avoided by the industry.

The viscosity of ultra dilute, dilute and semi-dilute fabric conditioning compositions can be increased by including polymeric viscosity control agents, for example starches and cellulose ethers. However, these conventional viscosity control agents are expensive materials. Furthermore, conventional polymeric viscosity control agents tend to show a drop in viscosity upon storage. Additionally, they typically require a separate gelatinization stage, in which they are mixed with water, which can increase the complexity and expense of the manufacturing process.

Cationic linear or cross-linked polymers are well-known in the art as ingredients to provide apparent viscosity in fabric softener compositions. Linear cationic polymers having high molecular weights are known to provide high flow elasticity to liquid fabric softeners, but the resulting compositions are often sensitive to inorganic electrolytes and high shear resulting in liquid products which are generally unstable and separate into different phases upon aging.

Many current fabric softener compositions use heteropolysaccharides such as xanthan gums as rheology modifiers. The xanthan gums are dry materials and therefore require a make down step to slurry or disperse the material into the fabric softener composition. In addition, xanthan gums are a source for microbial growth. Microbial contamination causes a loss of viscosity in the fabric softener composition and subsequent spoilage of the product.

While the use of polymeric thickeners to enhance consumer appeal is widely known in the prior art, there remains a need for liquid fabric softeners wherein the rheological properties of viscosity can be modified and which will work with liquid laundry care agents without adversely affecting the dispersion, dissolution and stability of the same.

### DETAILED DESCRIPTION OF THE INVENTION

It is thus an object of this invention to produce a stable aqueous dispersion utilizing a multi-branched soil release/wetting agent in an amount of between 0.05 and 3% by weight of the aqueous dispersion and particles, where the particle dispersion is stable for at least 10 days at 40° C.

The chemistries of the invention pose several formulation advantages over the traditional non-ionic, cationic and anionic systems. When introducing cationic additives, there is a concern of disrupting the effectiveness of the conditioner. When using anionic additives with fabric conditioners, there is a concern for their compatibility and stability within a cationic system. The emulsions and dispersions of the invention are stable in low (3) and high (10) pH systems. Additionally, each of the three chemistries are liquids, allowing for easier manufacturing, with no gelatinization step required. The invention chemistries are biodegradable (does not harm the environment or is and/or becomes harmless after degradation) thus can be used in several down the drain applications without the fear of damaging the environment. Preferably, the chemistries of the invention are aqueous dispersible in hot and cold water (5 to 50° C.).

All three aspects of the invention add the benefit of being able to suspend particles or other non-soluble additives in stabilized fabric conditioner without the articles settling out. The chemistries may be added to the final fabric conditioner without further modification of the formulation or may be formulated into a new fabric conditioner system. Other added benefits include ease of ironing, improved anti-static properties, improved fragrance retention/delivery and improved breathablility on fabrics.

The multi-branched soil release/wetting agent has an oxygen-containing polyfunctional base compound and at least two surfactant branches attached thereto, wherein each surfactant branch includes at least one hydrophilic and at least one hydrophobic constituent. These soil release/wetting agents (ethoxylated propoxylated triglycerides, ethoxylated propoxylated sorbitol) have previously been used as wetting agents for lawns and soils, see U.S. Pat. Nos. 6,857,225 and 6,948,276, which are incorporated by reference. Applicants have found that these soil release/wetting agents substantially stabilize emulsions and dispersions and thicken emulsions such as fabric conditioners to produce a higher viscosity and more stable solution.

The multi-branched soil release/wetting agent preferably includes at least one multi-branched oxygen-containing polyfunctional compound-based multi-branched soil release/wetting agent. Such a polyfunctional compound may be a polyol, a polycarboxylic acid, a lactone (the ring structure of which will open upon reaction to provide the necessary reactive sites for surfactant addition thereto), an amino acid, or mixtures thereof, wherein the moieties include reactive end groups for reaction with surfactant-like groups to form the desired branches therein. In such a base compound, the oxygen-containing functionalities (oxygen alone, or as part of a carboxylic acid group) provide the reactive sites and thus act as linking groups between the base compound and the surfactant-like branches. Alternatively, in cases where both oxygen-containing functionalities and nitrogen-containing functionalities are present, such as in amino acids, both functionalities may provide reactive sites which act as linking groups between the base compound and the surfactant-like branches.

The term polyol, for this invention, basically covers any compound with at least three hydroxyl moieties thereon. Likewise, polycarboxylic acid encompasses compounds having at least three such acid moieties present thereon. Lactone is a heterocyclic compound with at least two oxygen groups thereon. Amino acid generally encompasses any of the amino acids having a carboxylic acid and an amino functional group attached to the same tetrahedral carbon atom.

Thus, particular classes of polyols suitable for this purpose include, without limitation, tri- to octa-hydric alcohols such as pentaerythritol, diglycerol, α-methylglucoside, sorbitol, xylitol, mannitol, erythritol, dipentaerythritol, arabitol, glucose, sucrose, maltose, fructose, mannose, saccharose, galactose, leucrose, and other alditol or sugar molecules or polysaccharides; polybutadiene polyols; castor oil-derived polyols; hydroxyalkyl methacrylate copolymers; hydroxyalkyl acrylate polymers; polyvinyl alcohols; glycerine; 1,1,1-trimethylolpropane; 1,1,1-trimethylolethane; 1,2,6-hexanetriol; butanetriol; and mixtures thereof. Potentially preferred base compounds are the alditol types, particularly sorbitol and sucrose. Suitable polycarboxylic acids include, without limitation, tartaric acid; citric acid; ascorbic acid; 2-phosphono-1,2,4-butane tricarboxylic acid; glucuronic acid; ethylenediaminetetraacetic acid; gluconic acid; cyclohexane hexacarboxylic acid; mellitic acid; saccharic acid; mucic acid; diethylenetriamine pentaacetic acid; glucoheptonic acid; lactobionic acid; 3,3′,4,4′-benzophenone tetracarboxylic acid; amino propyl trimethoxysilane; aminopropyltriethoxysilane; 3-glycidoxypropyltrimethoxy silane; 3-glycidoxypropyltriethoxysilane; 3-(triethoxysilyl)propyl isocyanate; 3-(trimethoxysilyl)propyl isocyanate; diaminopropane-N,N,N′,N′-tetraacetic acid; aconitic acid; isocitric acid; 1,2,3,4-butanetetracarboxylic acid; nitrilotriacetic acid; tricarballylic acid; N-(phosphonomethyl)iminodiacetic acid; 3-[[tris(hydroxymethyl)methyl]amino]-1-propanesulfonic acid; 2-[[tris(hydroxymethyl)methyl]amino]-1-ethanesulfonic acid; 3-[bis(2-hydroxyethyl)amino]-2-hydroxy-1-propanesulfonic acid; 3-[N-trishydroxymethylmethylamino]-2-hydroxypropanesulfonic acid; N-tris[hydroxymethyl]methyl-4-aminobutanesulfonic acid; 3-aminoadipic acid; 1,3-diamino-2-hydroxypropane-N,N,N′,N′-tetraacetic acid; triethylenetetraaminehexaacetic acid; β-carboxyaspartic acid; α-hydroxymethylaspartic acid; tricine; 1,2,3,4-cyclopentanetetracar- boxylic acid; 6-phosphogluconic acid; and mixtures thereof.

Suitable lactones include, without limitation, glucoheptonic lactone and glucooctanoic-.gamma.-lactone. Suitable amino acids include, without limitation, aspartic acid, α-glutamic acid, and β-glutamic acid.

The multi-branched soil release/wetting agent preferably comprises ethoxylated propoxylated triglycerides, ethoxylated propoxylated sorbitol, or both. More detailed description of the preferred chemistries and synthesis techniques and processes may be found in U.S. applications 2005/0193791, 2005/0028442, 2004/0261314 and U.S. Pat. Nos. 6,948,276 and 6,857,225, (products are referred to as wetters) all of which are incorporated by reference.

The multi-branched soil release/wetting agent is added in an amount between 0.05 to 3% by weight of the aqueous dispersion. It was surprising that such small amounts of the multi-branched soil release/wetting agent could produce stable dispersions. The viscosity of the stable dispersion ranges from 50 to 800 cps (as measured on a Brookfield RVT, 50 prm, Spindle 2), with a preferred range between 50 to 500 cps. Acceptable fabric conditioners have an apparent viscosity of at least 50 cps. When the invention chemistries are used at these levels (0.01-10%), they also act as emulsion stabilizers. Thus the fabric conditioners (which are typically unstable white cast emulsions) are stabilized by the enhancer and resist phase separation and particle flocculation, even under extreme conditions, such as a 40° C. oven for more than 60 days. This is also observed with other emulsions and is not limited to fabric conditioners. This increase in stability enables valuable formulation flexibility and consistent performance during manufacturing, storage, and shipping and an increase in shelf life.

The multi-branched soil release/welting agent allows for the successful suspension of particles which can enhance the dispersion or emulsion (such as a fabric conditioner) aesthetically (for example adding pearlescence, iridescent or shimmer effects) or functionally (for example, adding antimicrobial, soil release properties). It has been observed that the addition of the chemistries of the invention to a fabric conditioner improves the particle dispersion stability or crash out rate (slowing it down) of articles in fabric conditioners (emulsions in general) avoiding settling or flocculation in the fabric conditioner system. The particles suspended consist of a size range between 50 nm and 45 μm, preferably 100 nm and 30 μm. Thus it is possible to add 0.01-10% of the appropriate articles by weight of fabric conditioner and added chemistry, preferably between 0.05-3.5%. The articles may be inorganic or organic particles, gases or other liquids, preferably particles. The particles used include but are not limited to phyllosilicate minerals (silicates class including mica), mica coated with a metal oxide (titanium dioxide, iron oxide, chrome oxide, etc.) to give colors (Lumina series by Engelhard), transition metal oxychlorides, aluminum oxides (Silvet/Silvex series by Silberline), titanium dioxides, any core material (aluminate, carbonate, silicate) coated with a metal oxide, silver zirconium hexaphosphates, silver glass. Organic polymers: homopolymers of acrylic acid (Miracare XC series by Rhodia Chemie), copolymers of acrylic acid and other monomers (Neocryl series by Avecia Resins), fluorinated derivatives (Lumiflon E-3029 by Asahi Glass), silicone based derivatives (Hycar 26348 by Goodrich), diisocyanates (Neopac E-106 by Avecia Resins).

In addition to the multi-branched soil release/wetting agent above, it has been found that by using glycerin, sorbitol and other ethoxylated, propoxylated saccharide or polysaccharide based compounds or ethoxylated, propoxylated water-soluble waxes (ex. Pluronics, or AA-401 (Milliken & Co.)) as additives to fabric conditioners increases the viscosity. Examples of the types of materials described above include Sorbitol alkoylate based wetters, Sucrose alkoylate based wetters and triglyceride alkoxylates by Milliken & Co.

Another embodiment of the invention consists of using tridecyl-alcohol ethoxylates in combination with the soil release/wetting agents and fabric conditioners for gelling/thickening the fabric conditioner.

Gels are generally formed when attractions between molecules (such as via hydrogen bonding, Van der Waals forces, ionic attractions, pi-pi interactions, etc.) facilitate the formation of an extensive three-dimensional strand network that traps and/or encapsulates (i.e., immobilizes) a solvent component between such strands (such as via hydrogen bonding). Gelling agents have been utilized in various applications for many years, particularly in terms of immobilizing certain solvents, mostly polar in nature, for improvements in storage and delivery thereof. Most importantly, and particularly for consumer purposes (personal care products, cosmetics, antiperspirants, etc.), gelling agents have been prominent in permitting utilization of difficult-to-handle and/or difficult to apply beneficial solvents and active ingredients within such consumer product formulations. Generally, the presence of gelling agents provides formulation structure which, in turn, permits a more uniform and even application of desirable additives to target surfaces (skin, for example). Without such gelled systems, the solvents and/or actives present within such formulations would most likely precipitate out of solution or bloom to the surface, thereby creating a delivery problem with either too little or too great an amount applied to the target area (in our case fabric). In particular, certain organic solvents may provide excellent treatment effects, yet, due to high volatility (ex. fragrance), such materials are difficult to store and difficult to actually apply to target surfaces without losing the efficacy thereof. Therefore a need exists for gelling these types of materials (fabric conditioners or emulsions).

In one embodiment, the stable aqueous dispersion and/or the enhanced fabric conditioner formulation contains a gelling agent comprising tridecyl alcohol ethoxylate. It was found that the addition of tridecyl alcohol ethoxylates shifts the gel point of the fabric conditioner or other dispersions or emulsions to a lower concentration as well as forms a structured gel. These long chain alcohol ethoxylates were not expected to promote gel formation because gels are formed when attractions between molecules (such as via hydrogen bonding, Van der Waals forces, ionic attractions, pi-pi interactions, etc.) facilitate the formation of an extensive three-dimensional strand network that traps and/or encapsulates (i.e., immobilizes) a solvent component between such strands (such as via hydrogen bonding).

The process for the use of the multi-branched soil release/wetting agent or gelling agent is via addition into a fabric conditioner after formulation as a separate additive or incorporated into a new fabric conditioner formulation. The thickened fabric conditioner is preferably added to clothing via the rinse cycle of a typical clothes washing machine. After the thickened fabric conditioner is applied, it is rinsed off and the water is removed from the fabric. This may be accomplished by clothes dryer, air drying, or any other means. Once dried, the fabric preferably has a dynamic load between 0.24 and 0.60 Newtons and a static load 0.20 and 0.50 Newtons as measured by the AATCC friction test method. This range has been shown to provide ease of ironing for the treated and dried fabric.

Preferably, the gelling/multi-branched soil release/wetting agent from the group of tridecyl alcohol ethoxylates is in an amount of between 0.01 and 10% by weight of the fabric conditioner, preferably between 0.05 and 6% and the viscosity at 25° C. with a Brookfield RVT viscometer, spindle #2 and set the speed to 50 RPM is between 50 and 800 cps. It is also possible to use mixed multi-branched soil release/wetting agents and gelling agents, wherein the enhancer is in an amount of between 0.01 and 6.0% by weight of the fabric conditioner and the gelling/thickening agent (tridecyl alcohol ethoxylate) is in an amount of between 0.01 and 6.0% by weight of the fabric conditioner. More preferably, the enhancer is in an amount of between 0.05 and 3.0% by weight of the fabric conditioner and the gelling/thickening agent is in an amount of between 0.05 and 3.0% resulting in a viscosity at 25° C. with a Brookfield RVT viscometer, spindle #2 and set the speed to 50 RPM between 50 and 800 cps.

Another benefit of using these multi-branched soil release/wetting agent and gelling agents is that in addition to increasing emulsion stability, and viscosity, they also allow the successful suspension of particles which can enhance the fabric conditioner aesthetically (for example adding pearlescence, iridescent or shimmer effects) or functionally (for example, adding antimicrobial, soil release properties). It has been observed that the addition of the chemistries of the invention to fabric conditioner improves the particle dispersion stability or crash out rate (slowing it down) of articles in fabric conditioners (emulsions in general) avoiding settling or flocculation in the fabric conditioner system. Thus it is possible to add 0.01-10% of the appropriate articles by weight of fabric conditioner and added chemistry, preferably between 0.05-3.5%. The articles may be inorganic or organic particles, gases or other liquids, preferably particles. The particles can consist of a size range between 50 nm and 45 μm, preferably 100 nm and 30 μm. The particles used include but are not limited to phyllosilicate minerals (silicates class including mica), mica coated with a metal oxide (titanium dioxide, iron oxide, chrome oxide, etc.) to give colors (Lumina series by Engelhard), transition metal oxychlorides, aluminum oxides (Silvet/Silvex series by Silberline), titanium dioxides, any core material (aluminate, carbonate, silicate) coated with a metal oxide, silver zirconium hexaphosphates, silver glass. Organic polymers: homopolymers of acrylic acid (Miracare XC series by Rhodia Chemie), copolymers of acrylic acid and other monomers (Neocryl series by Avecia Resins), fluorinated derivatives (Lumiflon E-3029 by Asahi Glass), silicone based derivatives (Hycar 26348 by Goodrich), diisocyanates (Neopac E-106 by Avecia Resins).

### EXAMPLES

Table 1 shows the chemical compositions of the Examples and Comparisons.

TABLE 1
Chemical compositions of examples

| | Composition | Manufacturer |
|---|---|---|
| Control 1 | 100% Downy Ultra | Proctor and Gamble |
| Control 2 | 3.5% mica + 96.5% Downy Ultra | |
| Example 1 | Sorbitol 9000 80PO20EO based | Milliken Chemicals |
| | wetter in Downy Ultra | |
| Example 2 | Sorbitol 9000 10EO80PO10EO in | Milliken Chemicals |
| | Downy Ultra | |
| Example 3 | Triglyceride based alkoylate in | Milliken Chemicals |
| | Downy Ultra | |
| Example 4 | Tridecyl alcohol-8EO in Downy Ultra | Milliken Chemicals |
| Example 5 | 2% Sorbitol 9000 80EO20PO + 98% | Milliken Chemicals |
| | Downy Ultra | |
| Example 6 | 2% Sucrose 80PO20EO + 98% | Milliken Chemicals |
| | Downy Ultra | |
| Example 7 | 2% Sorbitol 9000 80PO202O + 98% | Milliken Chemicals |
| | Downy Ultra | |
| Example 8 | 1% Tridecyl alcohol-8EO + 99% | Milliken Chemicals |
| | Downy Ultra | |
| Example 9 | 2% Sorbitol 9000 80PO20EO + 3.5% | Milliken Chemicals |
| | mica + 94.5% Downy Ultra | |
| Example 10 | 1% Tridecyl alcohol-8EO + 1% | Milliken Chemicals |
| | Wetter62 + 3.5% mica + 94.5% | |
| | Downy Ultra | |

### Procedure for Determination of Viscosity in Fabric Softeners/Conditioners

Samples were prepared in 200 gram quantities, for example, to create a 1% by weight of additive solution; one would add 2 grams of the additive and take to 200 grams with the fabric conditioner. Next, the samples were mixed using a motorized overhead stirrer with a metal blade at a stir rate of 900 RPM for 10 minutes at 25° C. A Brookfield RVT viscometer, with a spindle #2 and set the speed to 50 RPM was used to measure viscosity in centipoises (cps).

TABLE 2
Viscosity in cps of different concentrations of Examples in Downy

| | Wt % in Downy | | | | | | | |
|---|---|---|---|---|---|---|---|---|
| | 0% | 0.5% | 1% | 2% | 4% | 6% | 8% | 10% |
| Example 1 | 92.8 | | 118.4 | 128 | 212 | 233 | 264 | 343 |
| Example 2 | 92.8 | 109 | 130.4 | 152 | 282 | 368 | 512 | 552 |
| Example 3 | 92.8 | | | 115 | 120 | 126 | 131 | 138 |
| Example 4 | 92.8 | | 19.2 | 160 | 532 | >800 | >800 | >800 |

As seen on Tables 2 the viscosity of the fabric conditioner can be increased by addition of the multi-branched soil release/wetting agents of the invention.

### Sample Preparation and Testing for Emulsion Stabilization

The samples were prepared in 200 gram quantities as above. Samples were tested from approximately 0.01% to 6% by weight of fabric conditioner (Downy Ultra (Procter & Gamble) or Snuggle (Unilever)). The mixture was stirred for 10 minutes to ensure homogeneity and placed into a 40° C. oven and for 60 days. The samples were checked daily and the number of days for phase separation (emulsion kick out) to occur was recorded.

TABLE 3
Emulsion stability of Examples versus the control

| Example | Emulsion Stability (Days stable at 40° C.) |
|---|---|
| Control 1 | 7 |
| Example 5 | >60 |
| Example 6 | >60 |
| Example 7 | >60 |
| Example 8 | >60 |

The multi-branched soil release/wetting agents show excellent emulsion stabilization properties when added to the fabric conditioner. The stability of the emulsion with the additive is much greater then that of the control (>8 times more stable). Other fabric conditioners and multi-branched soil release/wetting agents (as described in the embodiment) were also tested and have similar results. This holds true to other emulsions and is not limited to fabric conditioners.

### Sample Preparation for Particle Suspension and Crash-out Test

The enhancer was added at between 0.01% and 6% by weight of fabric conditioner (Downy Ultra (Procter & Gamble) or Snuggle (Unilever)) and mixed for 10 minutes to ensure homogeneity. Next, mica particles (Engelhard, 500 nm) were added at 3.5% by weight of fabric conditioner and stirred for 10 minutes. The order of addition can be modified with similar results. The samples were placed on a shelf at 27° C. were checked daily. The number of days for approximately 20% particulate settling to occur was recorded.

TABLE 4
Particle in Fabric conditioner stability test (settling test)

| Example | Particle stability (Days stable at 40° C.) |
|---|---|
| Control 2 | 6 |
| | (particle settling) |
| Example 9 | >30 |
| Example 10 | >30 |

The Examples 9 and 10 show suspended particles in the fabric conditioner for extended periods of time without particulate settling. As can be seen in the table, the Examples suspend particles >5 times longer than the control system.

These examples illustrate the practice of this invention and are not intended to be exhaustive of all possible variations of the invention. The invention has been described in detail with particular reference to certain preferred embodiments thereof, but it will be understood that variations and modifications can be effected within the spirit and scope of the invention.

As can be seen in Table 5 the use of the multi-branched soil release/wetting agent in combination with the colorant, significantly increases the deposition of the same onto the textile. There has been a 3 fold increase in deposition of the colorant onto the substrate, thus showing the higher deposition efficacy.

What is claimed is:

1. A stable aqueous dispersion comprising:
a multi-branched soil release/wetting agent having an oxygen-containing polyfunctional base compound and at least two surfactant branches attached thereto, wherein each surfactant branch includes at least one hydrophilic and at least one hydrophobic constituent, wherein the multi-branched soil release/wetting agent is in an amount of between 0.05 and 3% by weight of the aqueous dispersion;
particles selected from the group consisting of inorganic, organic, and polymeric particles having a size range between 50 nm and 45 μm,
wherein the particle dispersion is stabilized for at least 10 days at 40° C.

2. The stable particle dispersion of claim 1, wherein the multi-branched soil release/wetting agent comprises at least three surfactant branches attached thereto, wherein each surfactant branch includes at least one hydrophilic and at least one hydrophobic constituent.

3. The stable particle dispersion of claim 1, wherein the multi-branched soil release/wetting agent is selected from the group consisting of ethoxylated propoxylated triglyceride, ethoxylated propoxylated saccharide, and mixtures thereof.

4. The stable aqueous dispersion of claim 1, wherein the oxygen-containing polyfunctional base compound is selected from the group consisting of a polyol, a polycarboxylic acid, and a lactone.

5. The stable aqueous dispersion of claim 4, wherein the polyfunctional base compound is a polyol selected from the group consisting of sorbitol, xylitol, mannitol, pentaertythritol, sucrose, saccharose, galactose, leucrose, fructose, mannose, glucose, glycerol, glycerine and polyethylene glycol.

6. The stable aqueous dispersion of claim 1, wherein the viscosity of the aqueous dispersion at 25° C. with Brookfield RVT viscometer, spindle #2 and 50 RPM is between 50 and 800 cps.

7. The stable particle dispersion of claim 1, further comprising a gelling agent comprising tridecyl alcohol ethoxylate.

8. The stable aqueous dispersion of claim 7, wherein the multi-branched soil release/wetting agent is in an amount of between 0.05 and 3.0% by weight of the aqueous dispersion, the gelling agent is in an amount of between 0.05 and 3.0% by weight of the aqueous dispersion.

9. The stable aqueous dispersion of claim 1, wherein the particles are added in an amount of between 0.05 and 3.5% by weight of the aqueous dispersion.

10. The stable aqueous dispersion of claim 1, further comprising a fabric conditioning agent.

11. An enhanced fabric conditioner formulation comprising:
a fabric conditioning agent;
a multi-branched soil release/wetting agent having an oxygen-containing polyfunctional base compound and at least two surfactant branches attached thereto, wherein each surfactant branch includes at least one hydrophilic and at least one hydrophobic constituent, wherein the multi-branched soil release/wetting agent is in an amount of between 0.05 and 3% by weight of the fabric conditioner;
particles selected from the group consisting of inorganic, organic, and polymeric particles having a size range between 50 nm and 45 μm,
wherein the stable particle dispersion is stable for at least 10 days at 40° C.

12. The enhanced fabric conditioner of claim 11, wherein the multi-branched soil release/wetting agent is selected from the group consisting of ethoxylated propoxylated triglyceride, ethoxylated propoxylated saccharide, and mixtures thereof.

13. The enhanced fabric conditioner of claim 11, wherein the viscosity of the enhanced fabric conditioner at 25° C. with Brookfield RVT viscometer, spindle #2 and 50 RPM is between 50 and 800 cps.

14. The enhanced fabric conditioner of claim 11, further comprising a gelling agent comprising tridecyl alcohol ethoxylate.

15. The enhanced fabric conditioner of claim 14, wherein the multi-branched soil release/wetting agent is in an amount of between 0.05 and 3.0% by weight of the fabric conditioning agent, the gelling agent is in an amount of between 0.05 and 3.0% by weight of the fabric conditioning agent, and the viscosity at 25° C. with a Brookfield RVT viscometer, spindle #2 and 50 RPM is between 50 and 800 cps.

16. The enhanced fabric conditioner of claim 11, wherein the enhanced fabric conditioner is biodegradable.

17. The enhanced fabric conditioner of claim 11, wherein the particles are added in an amount of between 0.05 and 3.5% by weight of the fabric conditioning agent.

18. The process of applying enhanced fabric conditioner to a fabric comprising:
washing a fabric with a detergent and water;
adding an enhanced fabric conditioner formulation a rinse cycle, the enhanced fabric conditioner formulation comprising:
an aqueous solution, a fabric conditioning agent, a multi-branched soil release/wetting agent having an oxygen-containing polyfunctional base compound and at least two surfactant branches attached thereto, wherein each surfactant branch includes at least one hydrophilic and at least one hydrophobic constituent, and wherein the multi-branched soil release/wetting agent is in an amount of between 0.05 and 3% by weight of the fabric conditioner, particles selected from the group consisting of inorganic, organic, and polymeric particles having a size range between 50 nm and 45 μm, wherein the stable particle dispersion is stable for at least 10 days at 40° C.; and,
removing the water from the treated fabric.

19. The process of claim 18, wherein the dried treated fabric has a dynamic load of between 0.24 and 0.60 Newtons and a static load of between 0.20 and 0.50 Newtons as measured by the AATCC friction test method.

20. The process of claim 18, wherein the enhanced fabric conditioner formulation comprises a gelling agent comprising tridecyl alcohol ethoxylate.
